(19) United States
(12) Patent Application Publication
(10) Pub. No.: US 2013/0196156 A1
(43) Pub. Date: Aug. 1, 2013

(54) CHEMICAL TREATMENT OF CARBON NANOTUBE FIBRES

(71) Applicants: Krzysztof Koziol, Cambridge (GB); Slawomir Boncel, Jaworzno (PL); Alan Windle, Cambridge (GB); Rajyashree Sundaram, Chennai (IN)

(72) Inventors: Krzysztof Koziol, Cambridge (GB); Slawomir Boncel, Jaworzno (PL); Alan Windle, Cambridge (GB); Rajyashree Sundaram, Chennai (IN)

(73) Assignee: CAMBRIDGE ENTERPRISE LIMITED, Cambridge (GB)

(21) Appl. No.: 13/696,582

(22) PCT Filed: Apr. 21, 2011
(86) PCT No.: PCT/GB2011/050798

§ 371 Date: Jan. 28, 2013

(30) Foreign Application Priority Data
May 6, 2010 (GB) 1007571.1

(51) Int. Cl. C08F 36/20

(52) U.S. Cl. CPC C08F 36/20
USPC 428/367; 427/221; 427/512; 525/313; 525/50

(57) ABSTRACT

The polymerisation of material contained within and/or added to high temperature reactor produced carbon nanotube fibre wherein the contained material is crosslinked.

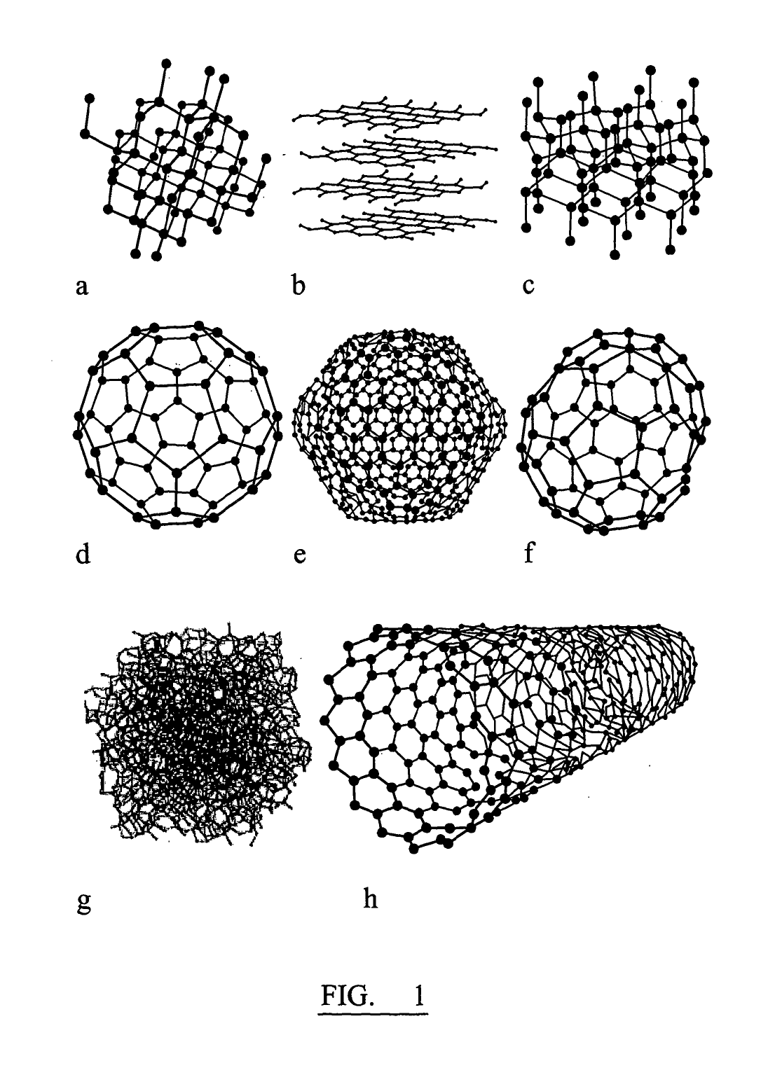

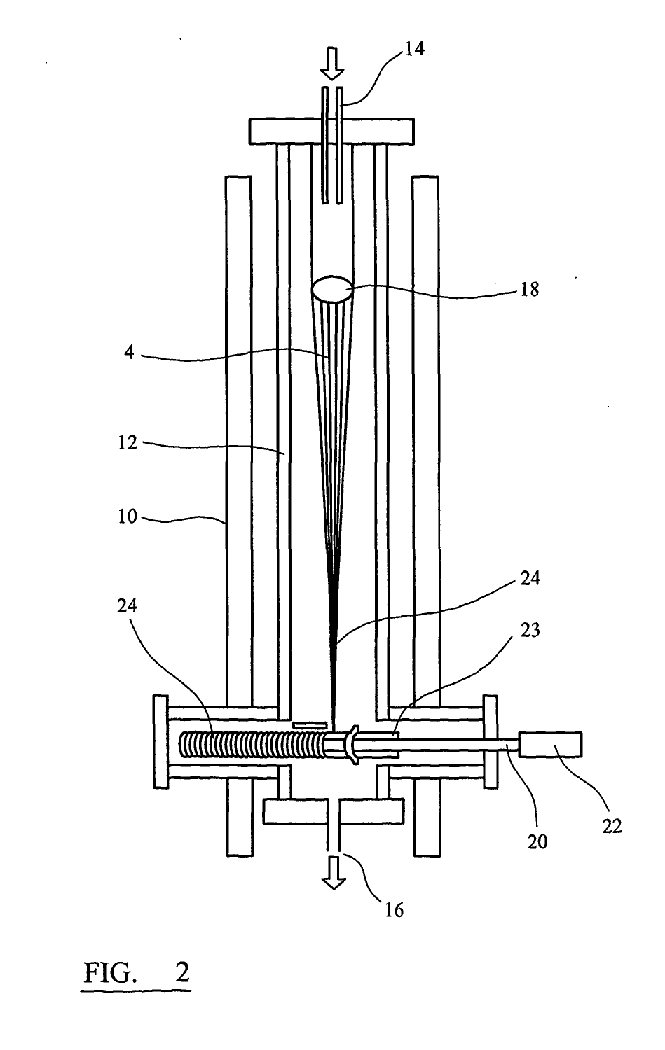

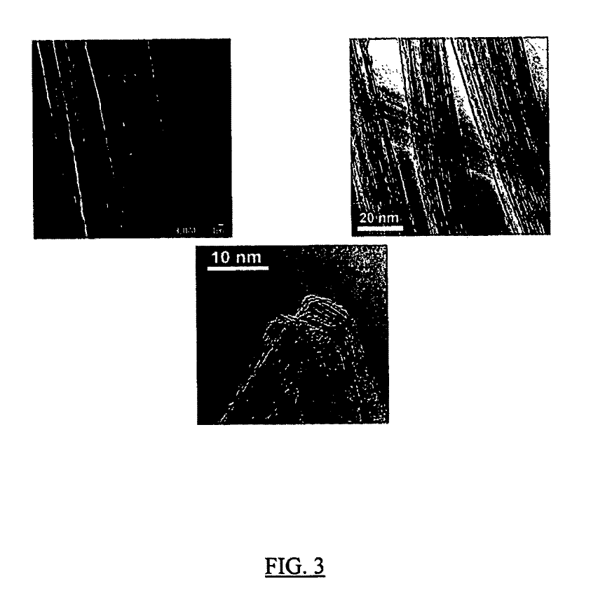

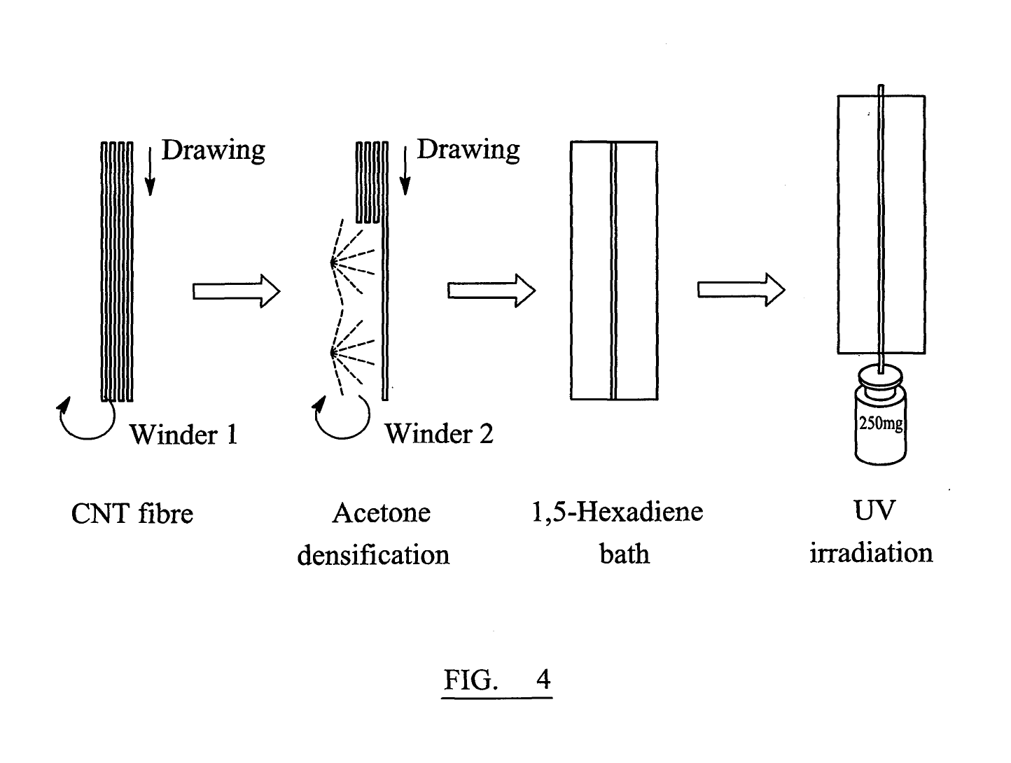

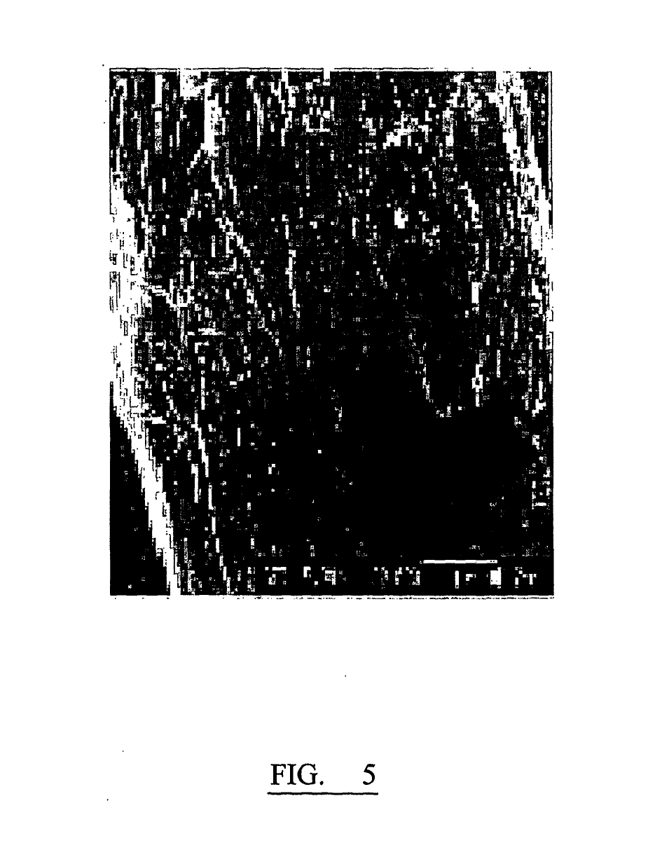

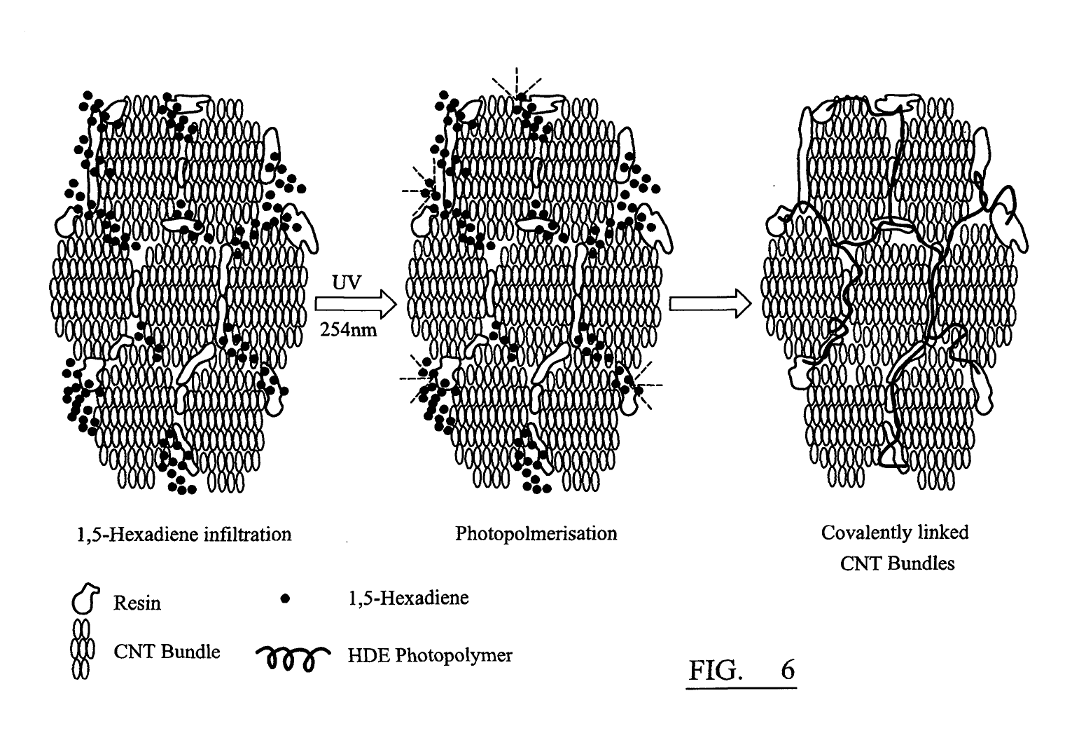

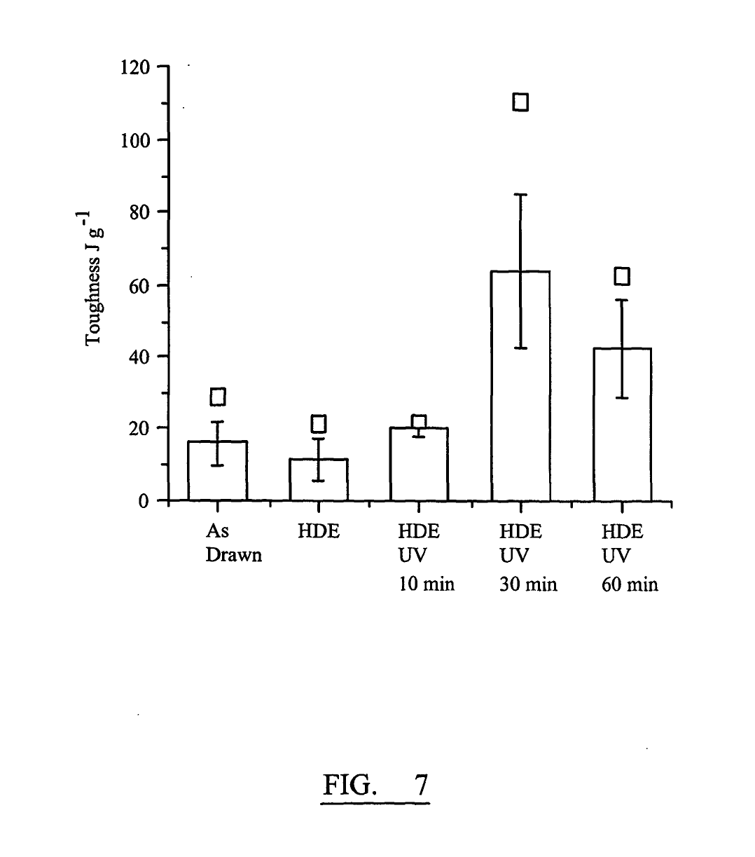

### BACKGROUND OF THE INVENTION

The Fullerene, discovered by Sir Harry Kroto, Richard Smalley and Robert Curl and others at Rice University Houston USA was identified as a new allotropic form of carbon.

[Ref. H. W. Kroto, J. R. Heat, E. C. O'Brien, R. F. Curl and R. E. Smalley (Nature 318, 162 1985).

Further work on the properties of fullerenes stimulated the interest of the global scientific research community which subsequently led to the identification of novel structural forms of carbon namely—the Carbon Nanotubes (CNTs).

[S. Iijima et al Nature 354, 56 1991]

Due to the unique chemical and electronic structures, fullerenes and CNTs exhibit remarkable mechanical, thermal and electrical properties which have gained widespread attention. The translation of the properties of individual nanotubes in to macroscopic entities such as fibres, yarns and films are bound to be interesting in terms of their cumulative properties. The potential applications of such materials range from their role as reinforcing agents in composites, alternative materials for power cables, cables for suspension bridges, biochemical and chemical sensors to catalyst supports.

Research at the Department of Materials Science and Metallurgy, University of Cambridge through the use of a high temperature reactor has resulted in bulk continuous production of high quality carbon nanotube macroscopic assemblies—in the form of fibres, films, tapes, yarns etc.

[Ref. Production of Agglomerates from Gas Phase WO/2005/07926

Cambridge University Technical Services Ltd Kinloch et al.]

### FIELD OF THE INVENTION

Yarns, tapes, ropes and fibres are produced from either single or multifilament elements that are either natural or synthetic or a mixture of both. Natural materials are exampled by wool, silk, cotton, hemp and flax, synthetic materials by nylon, acetate and polyester. Fibre as a filament artefact can be provided by most if not all of the aforementioned materials. It can be separated into single filament and multifilament types. The term—fibre—generically encompasses materials with aspect ratios (longitudinal dimension to lateral dimension), at a minimum >2. The invention herein described is concerned with multifilament fibres and as such the word fibre will be used in subsequent descriptions. Such fibres are held together by possible filament entanglement and forces of attraction exampled by weak Van der Waals forces. Each and every individual multifilament based fibre is particular and in most cases unique.

The aforementioned multifilament fibres have basic attributes that are defined by their structure produced during manufacture. Their structural configuration can be considered a ground state and its basic attributes comprise strength, stiffness, toughness, elongation at failure, knot strength efficiency, resistance to wear and tear, electron and phonon transport leading to thermal transfer and electrical conductivity characteristics. The combination of such attributes defines the cumulative properties of each and every individual multifilament fibre.

To change and/or enhance the basic mechanical properties of such fibres it is necessary to treat them with physical stimuli, chemical processes or both. Post fibre production treatments will render the fibre more suitable for later processing into useable product.

It is within the domain of multifilament fibre that the described invention resides, specifically the sub domain of carbon nanotube fibres and the enhancement of their mechanical properties.

Carbon nanotubes are allotropic form of carbon with 1-D nanostructures that display specific properties in their own right. They manifest themselves in a variety of forms exampled by single wall, double wall, triple wall, multiwall; along with further sub divisions based on the electronic behaviour into armchair, zigzag and chiral. Each variation and example has its own identity. Typically carbon nanotubes have diameters of 1 to 100 nanometres and aspect ratios ranging from 10:1 to greater than 1000:1.

In a high temperature reactor individual nanotubes can be persuaded to form collectively in a gaseous atmosphere, exampled by hydrogen, at temperatures between 400-1500° C. The thermal degradation of a feedstock containing a carbon source, exampled by aliphatic and aromatic alcohols or hydrocarbons (or a mixture) such as ethanol, methane etc., a catalyst precursor, exampled by ferrocene, and a promoter precursor exampled by thiophene, results in the growth of nanotubes that subsequently form a smoke, in the aforementioned gaseous atmosphere, which can be harvested continuously as a fibre. The fibre exits via a clear chamber in a gas valve containing no impediments which can hinder fibre collection. The gas valve separates the highly volatile reactor gases from the oxygen of the outside air in manner that prevents an explosion. When exiting from the reactor gas valve the carbon nanotube fibre is collected in a chosen manner exampled by spindle winding or deposition on a substrate.

In fibre form, the carbon nanotubes congregate either separately and/or as bundles of mainly longitudinally aligned individual nanotubes of varying length. They are held together by the previously mentioned entanglement and Van der Waals weak forces.

### FUNCTION OF THE INVENTION

The as made fibre drawn from the reactor is useful in its own right but with suitable after-treatments, its mechanical properties can be changed, enhanced and improved. The invention herein described alters the post-production fibre structure such that the mechanical properties, exampled by tensile strength, tensile stiffness, toughness, elongation to failure, knot strength efficiency, thermal and electron transfer characteristics, resistance to wear and tear are altered. Various post production processes can be applied to the fibre exampled by drawing, exposure to atmosphere controlled heat treatment (annealing), laser irradiation, any other form of electromagnetic radiation, acoustic stress, chemical procedures and densification techniques. The list is not definitive.

[Ref. Method of Increasing The Density of Carbon Nanotube Fibres or Films WO/2008/132467 A3]

High temperature reactor produced carbon nanotube fibre has a composite structure variously composed of individual nanotubes of varying length, bundles of nanotubes containing collections of tightly packed nanotubes along with gaps or vacancies. Once again the list is not definitive and nanotubes of different types, lengths, diameters and aspect ratios will be found. As aforementioned the nanotubes will typically align longitudinally parallel to the fibre axis.

For such a carbon nanotube fibre the application of a process which will produce enhancement of its mechanical properties by chemical treatments is the declared function of the described invention. Enhancement can be achieved through the addition of a chemical agent with its subsequent interaction with the post-production fibre.

### PRIOR ART

A. H. W. Kroto, J. R. Heat, E. C. O'Brien, R. F. Curl and R. E. Smalley (Nature 318, 162 1985).
B. S. Iijima Helical Microtubules of Graphitic Carbon Letter Nature 354 56-58 (Jul. 11, 1991)
C. M. Pick et al: Gas Isolation Valve WO/2006/100456 (Sep. 28, 2006)
D. A. Windle, I. Kinloch et al: Production of Agglomerates from Gas Phase WO/2005/007926 Pub. Feb. 20, 2007
E. A. R. Luther et al: Effect of Chemical Crosslinking on Films and Fiber Properties of some Amorphous Vinyl Polymers Journal of Applied Polymer Science Vol. 2 Issue 5 Pages 246-250. (Sep. 3, 2003)
F. Reine et al: Modification of Cotton Textiles and Cotton/Polyester Blends by Photo-Initiated Polymerisation of Vinylic Monomers U.S. Pat. No. 3,926,555 (Dec. 16, 1975)
G. P. Poulin et al: Composite Fibre Reforming and Uses Pub No. US 2004177451 (Sep. 16, 2004)

Prior art documents A to D places the described invention in its historical context. Kroto et al establishes the identification of Fullerene as a carbon allotrope, and Iijima et al the discovery of the carbon nanotube.

Documents C and D provide information of the formation of carbon nanotube fibre, specifically that which is produced though the use of a high temperature reactor and harvested through the aforementioned unimpeded gas isolation valve.

Document E describes polymerisation of CMC (Carboxyl Methyl Cellulose) yarns after immersion in a bath of aqueous formaldehyde solution and as such does not suggest internal capture of the polymer within fibre filaments and bundles formed of carbon nanotubes.

Document F describes a coating process for cotton/polyester yarns using vinylic monomers and specifically states that there is no, if any internal fibre intrusion (Paragraph 5). The polymerised vinylic monomers act only as a yarn coating and do not affect the internal structure in any way and as such the document has no relevance to the described invention.

1. A carbon nanotube fibre crosslinked with a polymerised added chemical.

2. A carbon nanotube fibre as claimed in claim 1 where said polymerised chemical is selected from polyalkanes.

3. A carbon nanotube fibre as claimed in claim 1 where said polymerised chemical is selected from polyalkenes.

4. (canceled)

5. A carbon nanotube fibre as claimed in claim 1 where said polymerised chemical is selected from polyaromatics.

6. A carbon nanotube fibre as claimed in claim 5 where said polyaromatics have hydroxyl, carbonyl and other moieties as side functional groups.

7. A carbon nanotube fibre as claimed in claim 1 where the fibre is produced in a high temperature reactor.

8. A carbon nanotube fibre as claimed in claim 7 where nanotube bundles are formed.

9. A carbon nanotube fibre as claimed in claim 7 where individual filaments are formed.

10. A carbon nanotube fibre as claimed in claim 7 where an amorphous resin is formed during the high temperature reaction.

11. (canceled)

12. A carbon nanotube fibre as claimed in claim 10 where the amorphous resin can be polymerised.

13. (canceled)

14. A carbon nanotube fibre as claimed in claim 8 where the amorphous resin covers the nanotube bundles.

15. A carbon nanotube fibre as claimed in claim 9 where the amorphous resin covers individual filaments.

16. A carbon nanotube fibre as claimed in claims 8 and 9 where the amorphous resin is critical to the tethering of the added crosslinking chemical to the carbon nanotube bundles and individual filaments that compose the fibre.

17. A carbon nanotube fibre as claimed in claim 16 where covalent linking between the nanotube bundles and individual filaments takes place because of the presence of the amorphous resin coating.

18. A carbon nanotube fibre as claimed in claim 1 where the crosslinked carbon nanotube fibre can be produced as yarn.

19. A carbon nanotube fibre as claimed in claim 1 where the crosslinked carbon nanotube fibre can be produced as tape.

20. A carbon nanotube fibre as claimed in claim 1 where the crosslinked carbon nanotube fibre can be produced as rope.

21. A carbon nanotube fibre as claimed in claim 1 where the crosslinked carbon nanotube fibre can be produced on film.

22. (canceled)

23. A method for improving the toughness value of drawn carbon nanotube fibres whereby said drawn carbon nanotube fibres are crosslinked with a polymerised added chemical selected from amorphous polymeric resin, said method comprising the steps of:
(a) applying to said drawn carbon nanotube fibres an amount of acetone whereby said fibres are densified;
(b) immersing said densified carbon nanotube fibres in a bath comprising said amorphous polymeric resin;
(c) recovering said carbon nanotube fibres from the bath; and
(d) exposing said carbon nanotube fibres to a polymerization stimulus selected from the group consisting of electromagnetic radiation, heat, acoustic stress and mechanical agitation.

24. The method as claimed in claim 23 wherein said amorphous polymeric resin is selected from the group of resins that will polymerize to form polyalkanes, polyalkenes and polyaromatics.

25. The method as claimed in claim 23 wherein said amorphous polymeric resin is 1,5 hexadiene and said polymerization stimulus is electromagnetic radiation comprising 254 nanometre wavelength ultra violet radiation at an output power of 8 watts.

26. The method as claimed in claim 23 or claim 24 wherein said carbon nanotube fibres are under tension when exposed to said polymerization stimulus.

27. The method as claimed in claim 24 wherein said polyaromatics have hydroxyl, carbonyl and other moieties as side functional groups.

28. The method as claimed in claim 23 wherein said drawn carbon nanotube fibres are arranged into nanotube bundles.

29. The method as claimed in claim 23 wherein said drawn carbon nanotube fibres are arranged to form filaments.

30. The method as claimed in claim 28 wherein said amorphous polymeric resin in step (b) covers said nanotube bundles.

31. The method as claimed in claim 29 wherein said amorphous polymeric resin covers said filaments.
